(19) United States
(12) Patent Application Publication
(10) Pub. No.: US 2002/0196333 A1
(43) Pub. Date: Dec. 26, 2002

(54) Mirror and image display system

(76) Inventor: Ignaz M. Gorischek, Dallas, TX (US)

Correspondence Address: CHRISTIE, PARKER & HALE, LLP, 350 WEST COLORADO BOULEVARD, SUITE 500, PASADENA, CA, 91105, US

(21) Appl. No.: 09/886,806

(22) Filed: Jun. 21, 2001

(51) Int. Cl. H04N 7/18

(52) U.S. Cl. 348/61; 386/46

(57) ABSTRACT

A vanity console display system is provided, comprising a vanity console, a variety of video image sources capable of providing different images, and a control unit. The vanity console has a mirror, an image display and a touch screen positioned on the mirror for use with the image display. The mirror has reflective and transmissive properties and the image display is positioned relative to the mirror such that is it hidden by the mirror and unseen to the user unless activated to provide an image that is transmitted through the mirror to the user. The control unit is connected to the various video image sources and is configured to receive user input signals from the touch screen for selecting and controlling the video image sources. As such, the transmitted image seen by the user may be varied as desired and selected by the user through the use of the touch screen.

### BACKGROUND OF THE INVENTION

It is known to marketeers that cosmetics are more readily purchased if they can be tested and sampled by customers. Because make-up items are typically nonexchangeable, consumers find it helpful to use the make-up and see it as applied before they purchase the product. For that very purpose, sample cosmetics labeled “testers” are often seen at cosmetics counters. Hence, as a marketing ploy, as well as a convenience to shoppers, cosmetics counters almost always provide a table-top vanity mirror.

As a further marketing ploy for cosmetics (if not all consumer items), informational commercials and promotional segments are often played within view of sales counters, or sometimes directly on the sales counters. VCR's and other comparable electronic equipment are used effectively in this capacity, as a relatively nonintrusive means to educate and entertain the shopper. A shopper may choose to watch the infomercials or video segments and do so without disturbing others. In this regard, an undecided shopper may well commit to a purchase once the shopper understands how the product is used or becomes informed on the benefits of the product.

Many retail establishments in promoting cosmetics also conduct in-store, live demonstrations by make-up artists who work directly with willing participants. The interactive nature of such demonstrations is invaluable in terms of enabling shoppers to simultaneously experiment with the products demonstrated and seek the advice of professionals. In this regard, a shopper may be more inclined to purchase a product once she knows which product best suits her needs and desires.

The aforementioned tactics work best when employed in combination with each other. However, the ability to combine these tactics with each other or with other marketing ploys may be hampered due to space and time constraints. Counter space and floor space in retail establishments are often limited. Moreover, time is of the essence in terms of capturing a shopper's attention. Furthermore, many finer retail establishments follow strict guidelines on maintaining their premises clean and orderly. Cluttered countertops and floor space pose a eye-sore for shoppers, if not also a safety hazard for shoppers and employees alike. Consequently, there is a desire to combine the foregoing marketing ploys in a manner that is both aesthetically pleasing and functionally efficient in terms of space and time.

### SUMMARY OF THE INVENTION

The present invention is directed to a vanity console display system, comprising a vanity console, a variety of video image sources capable of providing different images, and a control unit. The vanity console has a mirror, an image display and a touch screen positioned on the mirror for use with the image display. The mirror has reflective and transmissive properties and the image display is positioned relative to the mirror such that is it hidden by the mirror and unseen to the user unless activated to provide an image that is transmitted through the mirror to the user. The control unit is connected to the various video image sources and is configured to receive user input signals from the touch screen for selecting and controlling the video image sources. As such, the transmitted image seen by the user may be varied as desired and selected by the user through the use of the touch screen.

The video image source may be a video cassette player or a digital video disc player for entertaining, informing or educating the user, or even a face or body scanner such that “before and after” make-up tests may be conducted. The system may also include a printer or a projector responsive to the user input signals to print or project images from the video image sources. The system may further provide illumination devices so as to simulate “day-time” lighting or “night-time” lighting to assist the user in applying make-up.

The system may yet further be adapted to enable the application of cosmetics virtually, by providing a processor within the control unit to process the video image signals of a scanned body part, such as eyes, lips or even hands. The system may be rendered as interactive as desired by the user through the touch screen.

These, as well as other features of the invention, will become apparent from the detailed description which follows, considered together with the appended drawings.

### BRIEF DESCRIPTION OF THE DRAWINGS

In the drawings, which constitute a part of this specification, exemplary embodiments demonstrating various features of the invention are set forth as follows:

FIG. 1 is a perspective plan view of an embodiment of a mirror and image display system of the instant invention;

FIGS. 2A is side elevational view of an embodiment of a vanity console of the present invention (without a touch screen or a front frame member);

FIG. 2B is back elevational view of an embodiment of a vanity console of the present invention;

FIG. 2C is an exploded perspective view of an embodiment of a vanity console of the present invention; and

FIG. 3 is a block electrical circuit diagram showing the electrical circuit employed for an embodiment of the system of the present invention.

### DETAILED DESCRIPTION OF THE INVENTION

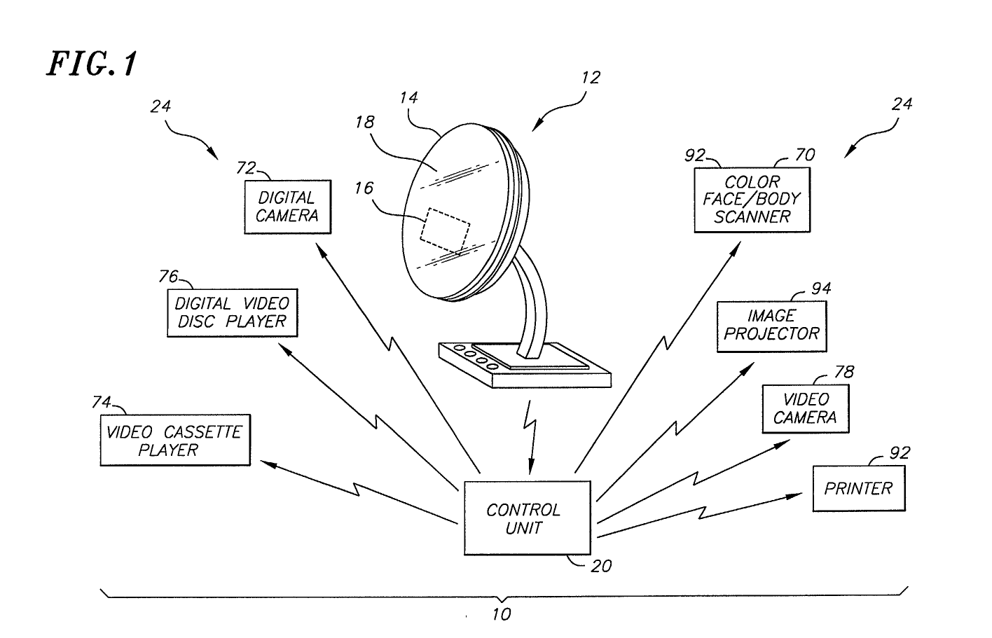

Referring to FIG. 1, the present invention is directed to a mirror and image display system 10 for use on counters, tables and the like. It may be used with cosmetics sales counters, jewelry sales counters, or with any sales counters which may benefit from a customer being able to see a reflection of his or her face or a body part. The system may also have use and application in a noncommercial setting, such as by individuals in a personal or private setting.

In a preferred embodiment of the invention, the system 10 includes a vanity console 12 having a mirror 14 and an image display 16 positioned behind the mirror and therefore hidden from a user unless activated to transmit images. To that end, the image display is adapted to receive video image signals and to work in conjunction with a touch screen 18 that is positioned on the mirror. The system further has a control unit 20 which is adaptable to provide many functions, and a plurality of video image sources 24 to output the video image signals to the image display 16.

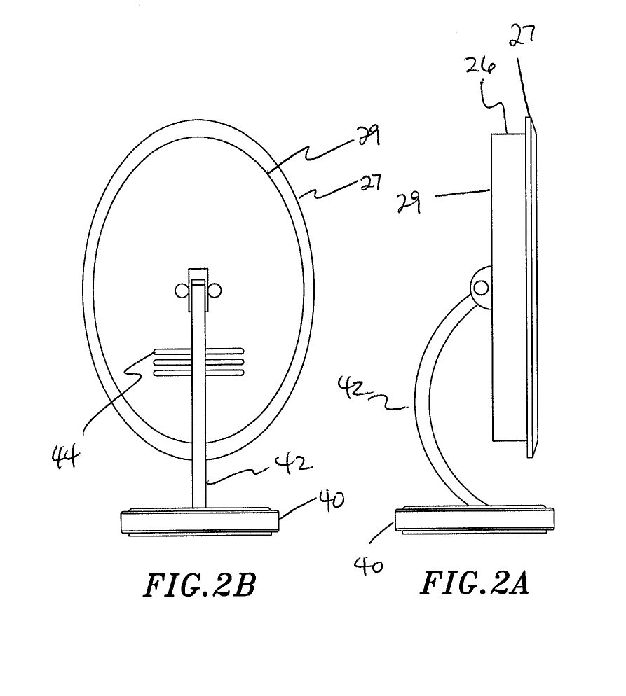

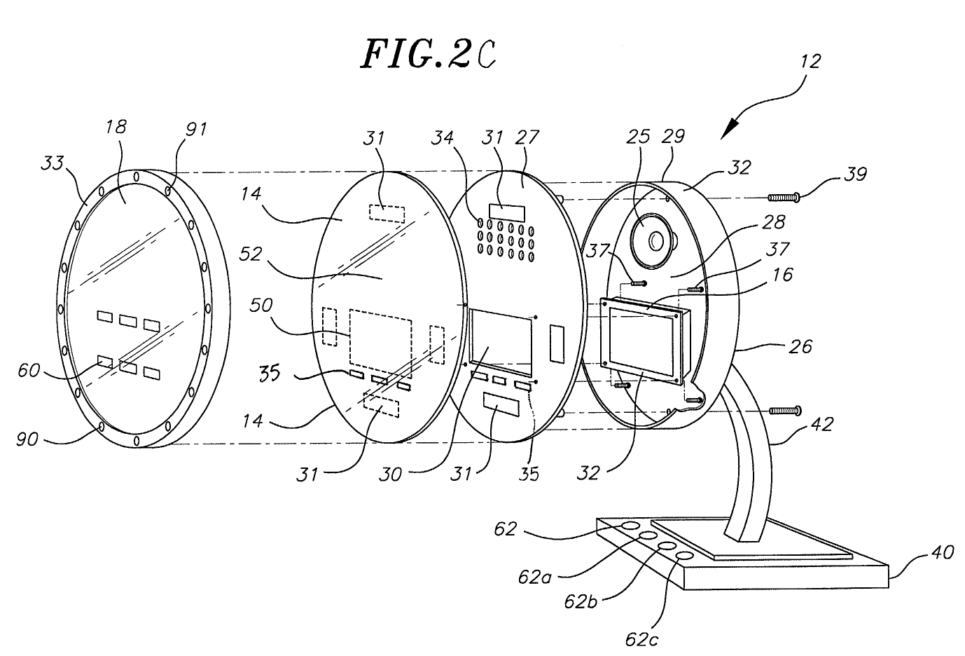

Referring to FIGS. 2A-2C, the vanity console 12 includes a stainless steel housing 26 comprising a plate member 27 and a back frame member 29 which together provide a cavity 28 therebetween in which the image display 16 is situated. The plate member 27 is configured with an opening 30 which receives the screen of the image display 16, and the image display 16 may be configured with a flange 32 by which the image display 16 is mounted onto the plate member 27 by screws 37, or the like. The plate member 27 is affixed to the back frame member 29 by screws 39, or the like. Also, situated in the cavity is an audio speaker 25 connected and configured within the system to transmit to the user any audio component from the video image sources. To that end, audio apertures 34 are provided in the plate member 27. Ventilation slots 44 are also provided.

The mirror 14, in turn, is mounted on to the plate member 27 by fasteners, for example, Velcro® tabs 31. The touch screen 18 is positioned on the mirror's outer surface so that the touch screen 18 may be accessed by a user. The touch screen 18 is transparent so that the video image on the image display 16 is visible through it. The touch screen may be, for example, a glass panel which is configured and shaped to correspond to the shape of the image display's screen. One type of touch screen is fitted with a number of relatively short spaced-apart linear electrodes extending along the perimeter of the touch screen.

An open front frame member 33 may be positioned outside of the touch screen 18 to secure and protect the touch screen 18. The front frame member 33 may be configured such that it readily snaps onto outer edge of the mirror 14 and plate member 27. Electrical connections for the touch screen 18 may be aesthetically routed within the front frame member 33. Moreover, the plate member 27 may be configured with aperture(s) to allow such electrical connections to be routed into the cavity 28 of the housing 26.

Supporting the housing 26 are a base 40 and a support arm 42 which also may be of stainless steel. The housing may be rigidly mounted on the support arm 42, or fasteners, such as pins and brackets may be used so that the housing is pivotable. The support arm 42 is of a hollow construction such that electrical connections or couplings to and from the vanity console 12 can be accomplished without being visible to the user of the present invention.

The mirror 14 has reflective characteristics such that its entire useable surface can be reflective to the user, for example, for applying make-up. However, the mirror also has transmissive characteristics such that when and where the image display 16 is activated to display an image, the image is transmitted and therefore visible to the user through the mirror 14. For purposes of describing the invention hereinafter, the mirror will be described as having a “reflected” image portion (or area) defined by the mirror's surface, and a “transmitted” image portion (or area) defined by the screen of the image display 16, even though it is understood that the mirror has substantially both reflective and transmissive characteristics throughout its surface.

In view of the foregoing, the mirror 14 has a reflected image portion 52 no greater than the entire useable mirror surface, and a transmitted image portion 50 lesser than the entire useable mirror surface defined by the screen of the image display 16 when operating. The touch screen 18 is positioned on the mirror 14 for use with the image display. As such, the user uses the system 10 by directing or “communicating” with the control unit via the touch screen. Such a function is to enable the user to select the image shown on the image display 16.

Any desired number of touch fields (or soft switches) 60 is provided by the touch screen 18. The touch fields 60 may include a variety of commands for operating the system 10, including commands to selectively control and actuate the video image sources 24.

The image display 16 can be a commercially available monitor equipped with a built-in light source suitable adopted to achieve and perform the video display function according to the invention. Alternatively, the image display can be a conventional flat screen color LCD type monitor. In any case, it is preferred that the display screen be of a suitable size relative to the size of the mirror such that the remaining reflected image portion of the mirror while the video image is being transmitted provides a suitable area of reflection for the user. For example, the display screen may be of a relative one-half to one-quarter the area of the mirror, such that the transmitted video image occupies one-half to one-quarter of the area of the mirror.

The base 40 of the vanity console may also provide other user input devices additional to the touch screen, such as selector switches 62. The switches 62 function comparably to the touch screen in terms of enabling the user to use the system 10. Like or in addition to the touch screen fields 60, the switches 62 may be video source selector switches or they may actuate other electrical components of the system 10.

In accordance with the present invention, at least certain of the touch screen fields 60 and the selector switches 62 are configured to enable the user to select the source of the video signals provided to the image display 16. In the context of the touch screen fields 60, the user at the prompting of suitable graphics or images on the image display 16, as controlled by the control unit 20, touches the field which corresponds to the video image source 24 she wishes to select. Referring again to FIG. 1, the video image sources 24 may include prerecorded and/or live video signal sources. Such video signal sources may be, for example, a color face/body scanner 70 and a digital camera 72 for providing prerecorded video signals of still images, a video cassette player 74 and a digital video disc player 76 for providing prerecorded video signals of dynamic images, and a video camera 78 for capturing and/or providing live, real-time video signals of still or dynamic images. Whereas the entire useable surface area of the mirror 14 is reflective to the user when the image display 16 is inactive or not actuated, the mirror 14 is transmissive in the region of the screen of image display 16 once the image display is operating or actuated.

The provision of prerecorded video images and live video images enables the system to flexibly accommodate the desires and needs of the user. Indeed, the possible uses and applications of the system depend in part on the imagination of the user. For example, the user may be educated, informed or entertained by the transmitted images in accordance with the user's selection of the various video image sources 24. Or, the user can conduct a “before and after” session to compare images of herself with and without cosmetics. By using the digital camera 72 or the scanner 70, the user first captures or scans in a “before” image of her face (or any other suitable body part). Thereafter, having applied the cosmetics, e.g., lipstick or nail polish, the user can compare the made-up body part (or “after” image) with her “before” image. In particular, by selecting the appropriate touch field(s) 60 for the system to display the “before” image on the image display 16, the user can look at the mirror and simultaneously see the transmitted “before” image along with the reflected “after” image.

Furthermore, the user by selecting the video player 74 or 76 as the selected video image source is able to experience and view through the transmitted image portion 52 of the mirror 14 a prerecorded video instructing on make-up application techniques. Or, the user by selecting the video camera 78 as the video image source can experience and view through the transmitted image portion 52 of the mirror a live demonstration, e.g., on make-up removal techniques, held at a remote locate that is captured by the video camera. The system 10 may even be adapted to process or alter the video signals so that cosmetics may be applied virtually, as explained in detail further below.

In the context of processing video signals, the system 10 can be adapted to allow the user to experiment with cosmetics virtually. To that end, the scanner 70 or the digital camera 72 of the system provides the system with video signals representative of the user's face or body. The user then selects via the touch screen a particular alteration, that is, a particular “cosmetics” to be applied virtually. As understood by one of ordinary skill in the art, the control unit 20 may include a processor adapted to process the video signals in accordance with the selection made by the user. For example, where the user's face is captured or scanned in and the user wishes to sample a shade of lipstick, the processor “applies” the selected shade of lipstick to the video image. In accordance with the selected virtual lipstick made by the user via the touch screen 18, the processor processes the video signals to generate an altered image bearing the selected shade of lipstick substantially in the region of user's lips in the video image. The processed video signals are then outputted from the processor to the image display which then displays the altered image to the user as a transmitted image through the mirror. In this manner, the user may experiment virtually with different lipstick shades, or any suitable cosmetics, without having to actually apply the cosmetics to the user's face or body.

The system is also configured to enable the user to activate other electrical components, such as special showcase illumination around the mirror, a printer 92 and/or a projector 94. The selector switches 62 on the base 40 of the vanity console 12 may be used to activate these components. The showcase illumination may include lighting elements 90 to generate illumination comparable to “daytime” lighting. The switch 62a may actuate additional lighting elements 91 or modify the intensity and/or shade of the lighting elements 90 to provide illumination comparable to “nighttime” lighting. Electrical connections may again be aesthetically routed within the front frame member 33.

Furthermore, switch 62b may be configured to activate and control the printer 92 to print an image captured or scanned into the system 10 and/or shown on the image display 16. The printer 92 may also be used to print other information such as preprogrammed information on the purchase of cosmetics products.

Moreover, switch 62c may be configured to activate and control the projector 94 for displaying to an audience on a large screen any image(s) including any captured or scanned image or preprogrammed image whether such image(s) are displayed on the image display 16 at the vanity console 12. The projector 94 may be a film projector, a slide projector, or any other projection device suitable for use with an audience. It is understood by one of ordinary skill in the art that the functions performed by the switches 62 may be incorporated completely or partially into the touch fields 60 of the touch screen 18.

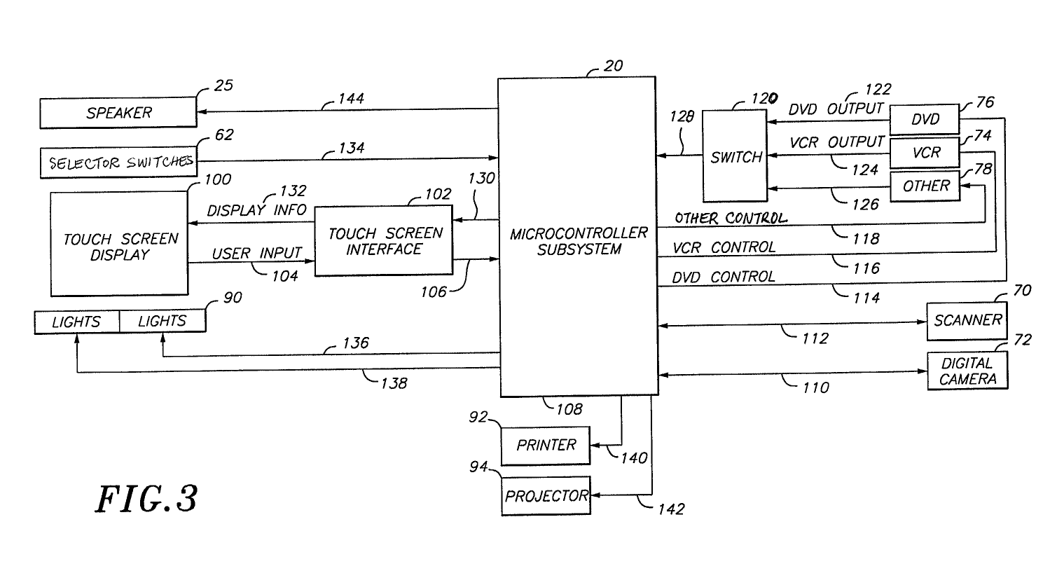

Referring to FIG. 3, a block electrical circuit diagram of the system 10. The touch screen 18 and image display 16 are shown in combination as a touch screen display 100 as understood by those of ordinary skill in the art. The touch screen display 100 is coupled to the control unit 20 via a touch screen interface 102 which receives user input signals via connection 104 and relays the user input signals to the control unit 20 via connection 106. The control unit 20, also referred to as a microcontroller subsystem 108 communicates with the plurality of video image sources 24, such as, the digital camera 72 via connection 110, with the scanner 70 via connection 112, with the video player 76 via connection 114, with the video player 74 via connection 116 and any other video image source including the video camera recorder 78 via connection 118.

Upon receiving the user input signals through the interface 102, the microcontroller 108 is adapted to activate and control any selected of the video image sources 24 and to receive the output video image signals therefrom. The microcontroller 108 communicates, controls and receives output video image signals from the digital camera via the connection 110 and the scanner via the connection 112. The system 10 provides a switch 120 for receiving output video image signals from the player 76 via connection 122, from the player 74 via connection 124 and from any other video image source 78 via connection 126. The switch 120 relays these output image signals to the microcontroller 108 via connection 128.

In receipt of the output image signals, the microcontroller 108 sends the signals to the touch screen interface 102 via connection 130 which then sends the signals to the touch screen display 100 via connection 132. Any audio signals from the DVD 76, VCR 74 or other image source 78 are also sent along connections 122, 124, 126 and 128.

As understood by one of ordinary skill in the art, the microcontroller 108 is configured and adapted to control the graphics or touch fields 60 displayed on the image display 16 for use with the touch screen 18. Moreover, if the output image signals are to be processed, as mentioned above for applying cosmetics virtually, the microcontroller subsystem 108 is configured to perform such processing on the signals and in turn output such altered or processed image signals to the touch screen display 100. The microcontroller subsystem 100 is programmed so that when the user touches a given field 60, the system 10 responds accordingly. To use the present system, the user touches the fields 60 which correspond to the video image source he wishes to select. The touch screen senses each touch and generates the corresponding user input signal which identifies the field.

The audio signals from the DVD 76, VCR 74 or other image source 78 are also processed by the microcontroller subsystem 108 and sent to the speaker 25 along connection 144.

The microcontroller subsystem is further adapted to activate and control the switch selectors 62 for illuminating the lights 90 via connections 134, 136 and 138. It is also adapted to activate and control the printer 92 via connection 140 and the projector 94 via connection 142. In this regard, the microcontroller subsystem 108 is configured to output to the printer 92 or the projector 94 image signals from any of the video image sources 24 or any image signals stored in the microcontroller subsystem 108, such as promotional or purchase information and materials.

It may be seen that the system of the present invention may be readily incorporated in various embodiments to provide a mirror and image display system. In one embodiment, the system comprises merely the vanity console 12 and a video image source, such as the VCR. As such, the output (video and any audio signals) of the VCR is fed directly to the image display 16. Upon activation of the VCR, the image display 16, otherwise hidden behind the mirror 14, is also activated to display image(s) in accordance with the VCR output, where such image(s) are viewed by the user through the mirror 14.

Moreover, in another embodiment of the system, the touch screen 18 (with or without the frame 33) may be replaced by or used along with other user input devices, such as detection/transducer devices 35 (see FIG. 2C), for receiving commands or input instructions from the user. The devices 35, which can be infrared or proximity sensors, can be positioned on the plate 27, behind the mirror 14, and be adapted to sense heat from the user's fingers through the mirror 14. To that end, the mirror 14 can be etched, or otherwise marked, so as to indicate to the user the location of the sensors 35 behind the mirror, or illumination devices can be mounted on the plate 27 for that same purpose. Alternatively, the devices 35 can also be positioned on the mirror 14. For either embodiment, the devices 35 may be electrically connected and configured for operation within the system comparably to the selector switches 62, as illustrated in FIG. 3.

It is understood by one of ordinary skill in the art that the various components described hereinabove may assume different configurations all accomplishing the same desirable result. It is also understood by one of ordinary skill in the art that the configurations and dimensions of various components may be altered and modified as desirable. In that regard, various alternative techniques and configures may be employed departing from those disclosed and suggested herein.

Consequently, it is to be understood that the scope hereof should be determined in accordance with the claims as set forth below.

What is claimed is:

1. A vanity console display system, comprising:
a vanity console having a mirror, an image display and a touch screen positioned on said mirror, said mirror having reflective and transmissive properties, said image display positioned relative to the mirror to provide a transmitted image to a user;
at least one video image source adapted to provide an image on the image display;
a control unit connected to said video image source and configured to receive user input signals from the touch screen for controlling the video image source to transmit signals representative of said image.

2. A vanity console display system of claim 1, wherein the video image source includes a VCR.

3. A vanity console display system of claim 1, wherein the video image source includes a scanner.

4. A vanity console display system of claim 1, wherein the video image source includes a DVD player.

5. A vanity console display system of claim 1, wherein the video image source includes a VCR.

6. A vanity console display system of claim 1, further comprising a printer.

7. A vanity console display system of claim 6, wherein the printer is responsive to the user input signals to print said image.

8. A vanity console display system of claim 1, further comprising a projector.

9. A vanity console display system of claim 8, wherein the projector is responsive to the user input signals to project said image.

10. A vanity console display system of claim 1, further comprising an illumination device mounted on said vanity console.

11. A vanity console display system of claim 1, wherein the video image source provides an audio component.

12. A vanity console display system of claim 1, wherein said vanity console has a housing, a base and a support arm extending between the housing and the base, said base configured for use with counters.

13. A vanity console display system, comprising:
a vanity console having a mirror, an image display and a touch screen positioned on said mirror, said mirror having reflective and transmissive properties, said image display positioned relative to the mirror to provide a transmitted image to a user;
a plurality of video image sources adapted to provide different images on the image display;
a control unit connected to said video image sources and responsive to user input signals from the touch screen for selecting and controlling the video image sources to transmit signals representative of said different images.

14. A vanity console display system of claim 13, wherein said signals comprise prerecorded video image signals.

15. A vanity console display system of claim 13, wherein the control unit comprising a processor for altering the video image signals.

16. A vanity console display system of claim 13, wherein the mirror provides a view to a user, the view comprises a transmitted image of a body portion of the user and a reflected image of the body portion.

17. A vanity console display system for use with a counter, comprising:
a vanity console having a mirror, an image display and a touch screen positioned on said mirror, said mirror having reflective and transmissive properties, said vanity console having a housing, a base and an arm extending between said housing and said base;
at least one video image source adapted to provide an image to the image display;
a control unit connected to said video image source and responsive to user input signals from the touch screen for actuating the image display and controlling the video image source to transmit signals representative of said image to the image display,
wherein said image display is positioned relative to the mirror such that it is hidden from a user unless actuated to transmit said image to the user through said mirror.

18. A vanity console display system of claim 17, wherein said video image source is a VCR.

19. A vanity console display system of claim 17, wherein the vanity console includes a housing defining a cavity in which the image display is positioned behind the mirror.

20. A vanity console display system of claim 17, wherein said mirror is adapted to provide to the user a view having a reflected image and a transmitted image, the transmitted image being the image provided by the video image source.

21. A vanity console display system for use with a counter, comprising:
a vanity console having a mirror and an image display, said mirror having reflective and transmissive properties, said vanity console having a housing, a base and an arm extending between said housing and said base;
at least one video image source adapted to provide an image to the image display;
wherein said image display is positioned relative to the mirror such that it is hidden from a user unless actuated to transmit said image to the user through said mirror.

22. A vanity console display system of claim 21, wherein said video image source is a VCR.

23. A vanity console display system of claim 21, further comprising a user input device, and the video image source is responsive to the user input device.
